(19) United States
(12) Patent Application Publication
(10) Pub. No.: US 2026/0335906 A1
(43) Pub. Date: Oct. 29, 2026

(54) SEPARATOR SYSTEM

(71) Applicant: WIJG Development, LLC, Lewes, DE (US)

(72) Inventors: Sirlance Nolasco, San Antonio, TX (US); Joseph Lanham, Tomball, TX (US); Floyd Hammond, Rogers, AR (US)

(21) Appl. No.: 19/662,965

(22) Filed: Apr. 29, 2026

Related U.S. Application Data
(60) Provisional application No. 63/796,830, filed on Apr. 29, 2025.

(51) Int. Cl. B04C 3/06; E21B 43/34

(52) U.S. Cl. CPC B04C 3/06; E21B 43/34

(57) ABSTRACT

A separator system has a vertical cyclonic separator with a gas outlet and a liquid outlet. A well fluid inlet conduit communicates with the vertical cyclonic separator. A gas flow conduit connects the gas outlet of the cyclonic separator to a horizontal three-phase separator and a liquid flow conduit connects the liquid outlet of the vertical cyclonic separator to the horizontal three phase separator.

### CROSS REFERENCE TO RELATED APPLICATION

The present application claims priority to U.S. Provisional Application No. 63/796,830 filed on Apr. 29, 2025, which is incorporated herein by reference.

### FIELD

The present disclosure generally relates to separation systems used in the oil and gas industry, and more specifically to a separator system that is modularized and adaptable to existing three-phase separators.

### BACKGROUND

Separators are commonly used in the oil and gas industry to separate produced well fluids into different components. Produced well fluid generally consists of different components, and typically consists of different ratios of oil, water, natural gas, and sediment. Horizontal three-phase separators are well known and are used to separate the produced fluid. Produced fluid will enter the three-phase separator and water and oil will flow out of outlets at the bottom and gas will flow from an outlet at the top. The oil and water separation results from the oil floating on the water, and typically an overflow weir will allow the oil to flow over the weir while preventing the water from doing so. While three-phase separators are adequate in many cases, more efficient separator systems are needed.

### BRIEF DESCRIPTION OF THE DRAWINGS

The drawings included with this application illustrate certain aspects of the embodiments described herein. However, the drawings should not be viewed as exclusive embodiments. The subject matter disclosed is capable of considerable modifications, alterations, combinations, and equivalents in form and function, as will occur to those skilled in the art with the benefit of this disclosure.

FIG. 1 is a depiction of a separator system.

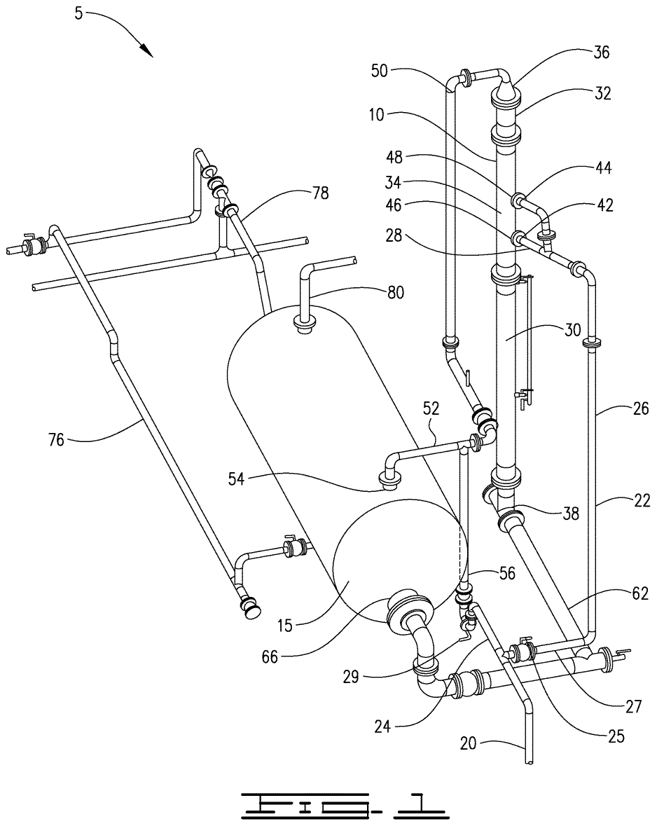

FIG. 2 is a line drawing of the fluid flow for the separator system.

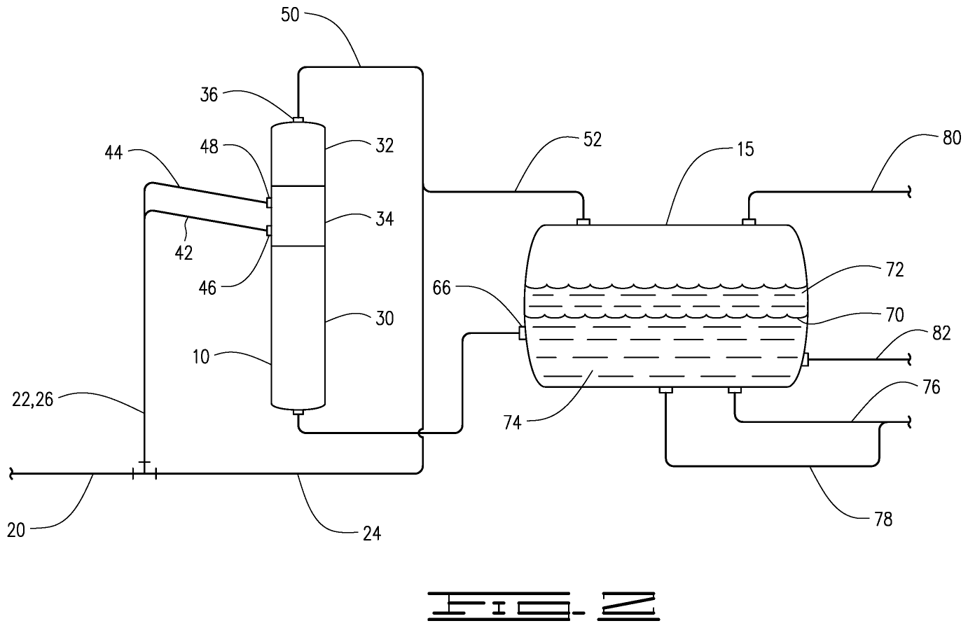

FIG. 3 shows a vortex breaker.

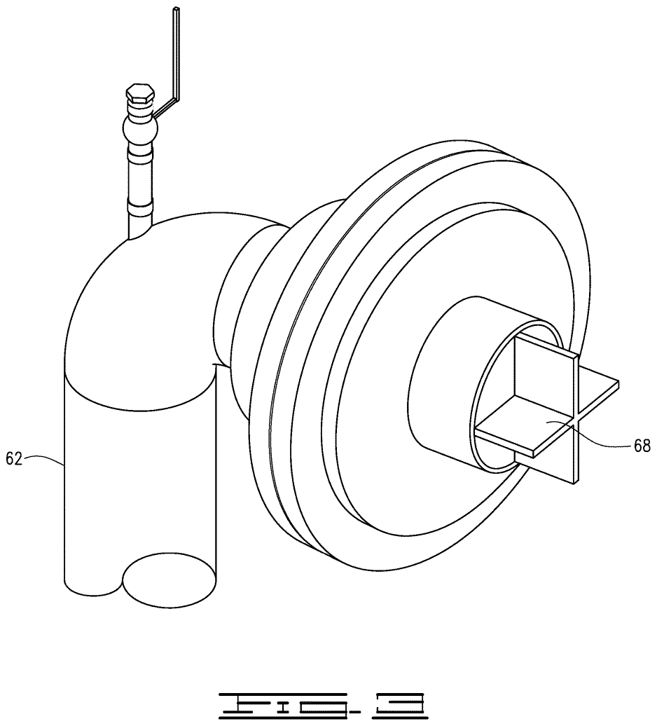

### DETAILED DESCRIPTION

The present disclosure may be understood more readily by reference to these detailed descriptions. For simplicity and clarity of illustration, where appropriate, reference numerals may be repeated among the different figures to indicate corresponding or analogous elements. In addition, numerous specific details are set forth to provide a thorough understanding of the various embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts have been exaggerated to better illustrate details and features of the present disclosure.

In the following descriptions and drawings, identical components are labeled with the same reference numerals throughout. Certain elements may be shown in schematic form for clarity, and variations in specific embodiments may be made without deviating from the scope of the invention.

Unless otherwise specified, terms such as “upstream,” “downstream,” “upper,” “lower,” “horizontal,” and “vertical” refer to relative positions within the tower and are not intended to impose strict geometric orientations.

Unless otherwise specified, use of the terms “connect,” “engage,” “couple,” “attach,” or any other like term describing an interaction between elements is not meant to limit the interaction to direct interaction between the elements and may also include indirect interaction between the elements described.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

Further, use of the term “plurality” is meant to convey “more than one” unless expressly stated to the contrary. The use of the term “at least one” or “one or more” will be understood to include one as well as any quantity more than one. In addition, the use of the phrase “at least one of X, V, and Z” will be understood to include X alone, V alone, and Z alone, as well as any combination of X, V, and Z.

The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Referring now to the Figures, a separator system of the current disclosure is illustrated and generally designated by the numeral 5. Separator system 5 comprises a vertical separator 10 fluidically connected to a horizontal separator 15. In one embodiment, the vertical separator 10 is a cyclonic separator and horizontal separator 15 is a horizontal three-phase separator. Separator system 5 has a system inlet conduit 20. System inlet conduit 20 will deliver produced well fluid to the separator system 5. System inlet conduit 20 diverges into two separate well fluid branches, including a first inlet branch 22 and a second inlet branch 24. First inlet branch 22 directs well fluid to vertical separator 10. Well fluid in first inlet branch 22 will be comprised of gas with liquid entrained therein. Second inlet branch 24 is a bypass conduit. Valves 25 and 29 can be utilized to prevent flow through first inlet branch 22 so that when second inlet branch 24 is used, well fluid bypasses vertical separator 10 and is directed into three-phase separator 15. Typically, well fluid will flow only in one of first and second inlet branches 22 and 24. In other words, in normal operation, valves 25 and 29 will be used to allow flow only through one of the branches. During the operation of the system 5, flow of well fluid will be directed into the cyclonic vertical separator 10. When the bypass line, second inlet branch 24, is open, first inlet branch 22 is closed off so that there is no flow into the three-phase separator 15. First inlet branch 22 has a first horizontal portion 27, a vertical portion 26 and a second horizontal portion 28.

Vertical cyclonic separator 10 may comprise a plurality of sections including a lower section 30, an upper section 32 and a nozzle section 34 positioned between the lower and upper sections 30 and 32. Lower, upper and nozzle sections 30, 32 and 34 may be connected with flanged connections, or other types of connections that allow for the easy and efficient removal and replacement of the sections. The vertical cyclonic separator may thus be non-destructively disassembled and reassembled. The vertical separator 10 is non-destructively reconfigurable in that the upper and lower sections 32 and 30 can be removed and replaced to accommodate different flow regimes, pressures, temperatures, and flow rates. Likewise, the nozzle section 34 is easily removed and replaced, so that different nozzle sections may be used to account for different nozzle designs, nozzle hardware, and nozzle geometry to accommodate different inlet pressures, temperatures, and fluid flow rates.

An upper cyclone separator outlet 36 is positioned at the upper end of cyclone separator 10. Upper outlet 36 is defined on upper section 32 and is a cyclone gas outlet. A lower cyclone separator outlet 38 is positioned at the lower end of cyclone separator 10. Lower outlet 38 is defined on lower section 30 and is a cyclone liquid outlet. System 5 includes first and second nozzles 42 and 44 which inject well fluid into cyclonic separator 10 at well fluid inlets 46 and 48. Although a pair of well fluid inlets 46 and 48 and first and second nozzles 42 and 44 are shown and described, it is understood that only one, or more than two well fluid inlets and nozzles can be included. The nozzles 42 and 44 may be horizontal, or may be directed downwardly at an angle from the horizontal between about 5° to 45° and may be for example about 27°. System 5 may thus have at least one well fluid inlet and one nozzle through which well fluid is directed into the cyclonic separator 10 and may have a plurality of well fluid inlets and nozzles. Nozzles 42 and 44 inject the well fluid tangential to the inner surface of the vertical separator 10 at a rate sufficient to create a swirling effect around the inner surface of the vertical cyclonic separator 10, which in the described embodiment is cylindrical. By injecting the well fluid tangent to the inner surface of the cyclonic separator 10, a swirling effect is created. By running the well fluid, which may contain for example, oil, gas, and water, across the inner surface of the vertical separator 10, a thin liquid film is developed. As a result, entrained gas bubbles can rise to the gas-liquid interface towards the center of the vertical cyclonic separator. The swirling motion inside the lower half of the cyclonic separator 10 will generate separation of gas from liquids and solids from liquids.

Gas exits gas outlet 36 and will be delivered into a gas outlet conduit 50. Gas outlet conduit 50 will be connected to three-phase separator gas inlet piping 52 for three-phase separator 15. Gas inlet piping 52 will connect to the three-phase separator gas inlet 54. Bypass conduit 24 is connected to a conduit 56, which is in turn connected to gas inlet piping 52 so that well fluid may be directed into three-phase separator 15 from bypass conduit 24.

Liquid exiting the bottom of vertical cyclonic separator 10 will flow into a liquid outlet conduit 62. Liquid outlet conduit 62 will be connected to three-phase separator 15 and will communicate liquid into the three-phase separator 15. Liquid outlet conduit 62 may be connected to the manway 66 on three-phase separator 15 so that liquid from the vertical cyclonic separator 10 will enter horizontally. A vortex breaker 68 or other flow straightener may be connected at the location in which liquid enters the three-phase separator 15 from the liquid outlet conduit 62. Vortex breaker 68 acts as a flow conditioner and will minimize turbulence that can create the undesirable result of mixing lighter liquid (oil) with heavier liquids (water). The horizontal inlet to separator 15 should be at a level just below the horizontal oil-water interface 70 between water 72 and oil 74 inside the three-phase separator 15 to aid in liquid-liquid separation and minimize turbulence at the gas-oil interface. Three-phase separator 15 will deliver gas to a gas outlet pipe 80 which delivers the gas to a desired location. Oil will be delivered to an oil outlet pipe 82 and then to a desired location. Water and solids will be communicated through a water outlet pipe 76 and will be disposed of in typical fashion.

Proper liquid level control in cyclonic separator 10 is important to the cyclonic separator efficiency. The vertical placement and horizontal distance of the cyclone separator 10 relative to three-phase separator 15 affects the liquid level in the cyclonic separator 10. It is well known that the level of liquid in the three-phase separator 15 is controlled by liquid level controllers of a type known in the art. The cyclonic vertical separator 10 should be positioned so that the liquid level in the cyclonic separator 10 is at the same level, or above the level of liquid level in the three-phase separator 15. A belly dump line 78 may be added to the three-phase separator 15 to allow solid material to be flushed out into the water. The separator system 5 provides a number of advantages over current separator systems including for example:
1. Providing a less intrusive, modular way of adding separation efficiency that is space saving and is easily adaptable to existing three-phase separators.
2. Providing an easily swappable “nozzle section” to increase ease of maintenance, and to allow modification of nozzle design, nozzle hardware, and nozzle geometry to cater to different inlet gas-oil ratios (GORs), water-oil ratios (WORs), gas-water ratios (GWRs), inlet pressures, temperatures, and volumetric flow rates.
3. Providing modular top and bottom sections to be able to accommodate different flow regimes, pressures, temperatures, and flow rates.
4. Use of manways or other horizontal nozzles to direct the inlet into the three-phase separator horizontally so the different density liquids separate more efficiently.
5. Installing a flow conditioner into the horizontal three-phase separator liquid inlet to minimize turbulence which mixes the lighter liquids (oils) with the denser liquids (water).
6. Installing the horizontal inlet of the separator at a level just below the horizontal oil-water interface inside the three-phase separator to aid in liquid-liquid separation and minimize turbulence at the gas-oil interface.
7. Improving three-phase separator separation efficiency by “degassing” the bulk inlet gas-oil-water mixture and separating the oil and water liquid phases from the gas phase.
8. Improving the three-phase separator separation efficiency by roughly coalescing liquids of similar densities in the inlet stream.
9. Using existing level controls or provide a new control infrastructure in the host three-phase separator to control the liquid level in the cyclonic separator.
10.The cyclonic separator can be broken into different pieces which can individually be optimized based on different dominant flow regimes with minimal disturbance to existing equipment (i.e., only parts of the cyclone must be changed to optimize performance instead of the entirety of the vessel).
11.A cyclonic separator can be connected to each of a plurality of three-phase separators in a separator installation which will generate a significant increase in separation efficiency.

Therefore, the present disclosure is well adapted to attain the ends and advantages mentioned, as well as those that are inherent therein. The embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered or modified, and all such variations are considered within the scope and spirit of the present disclosure. While apparatus and methods may be described in terms of “comprising,” “containing,” “having,” or “including” various components or steps, the apparatus and methods can also, in some examples, “consist essentially of” or “consist of” the various components and steps. Also, the terms in the claims have their plain, ordinary meaning unless otherwise explicitly and clearly defined by the specification.

What is claimed:

1. A separator system comprising:
a vertical cyclonic separator having a gas outlet and a liquid outlet;
a well fluid inlet conduit communicated with the vertical cyclonic separator;
a horizontal three-phase separator;
a gas flow conduit connected to the gas outlet of the vertical cyclonic separator and to the horizontal three phase separator; and
a liquid flow conduit connected to the liquid outlet of the vertical cyclonic separator and to the horizontal three phase separator.

2. The separator system of claim 1, the vertical cyclonic separator comprising:
a nozzle section with at least one well fluid inlet; and
a first nozzle connected to the at least one well fluid inlet, wherein the well fluid inlet conduit communicates well fluid to the at least one well fluid inlet through the first nozzle.

3. The separator system of claim 2, wherein the nozzle section is non-destructively removable and replaceable.

4. The separator system of claim 2, wherein the at least one well fluid inlet is tangent to the inner surface of the nozzle section of the cyclonic separator.

5. The separator system of claim 2, wherein the nozzle section has a plurality of well fluid inlets, each well fluid inlet having a nozzle connected thereto, and wherein the well fluid inlet conduit communicates well fluid to the plurality of well fluid inlets through the nozzles.

6. The separator system of claim 1, wherein the well fluid inlet conduit diverges into first and second well fluid inlet branches, wherein the first well fluid inlet branch communicates well fluid into the vertical cyclonic separator and the second well fluid inlet branch communicates well fluid directly into the three-phase separator and bypasses the vertical cyclonic separator.

7. The separator system of claim 1, wherein the liquid flow conduit directs liquid into the three-phase separator in a horizontal direction past a flow conditioner in the three-phase separator inlet.

8. A method of separating produced well fluid into constituent components comprising:
receiving the produced well fluid in a system inlet conduit;
directing the produced well fluid into a vertical cyclonic separator;
separating at least a portion of the liquids from the gas in the vertical cyclonic separator;
communicating gas from the vertical cyclonic separator into the three-phase separator; and
communicating liquid separated from the gas in the vertical cyclonic separator into the three-phase separator.

9. The method of claim 8, further comprising delivering the liquid from the three-phase separator into the three-phase separator in a horizontal direction.

10. The method of claim 8, further comprising injecting the produced well fluid into the vertical cyclonic separator tangent to the inner surface of the vertical cyclonic separator.

11. The method of claim 10, wherein the separation of gas from liquid in the vertical cyclonic separator occurs solely due to the swirling motion of the produced well fluid resulting from the tangential injection of the produced well fluid into the vertical cyclonic separator.

12. The method of claim 10, comprising injecting the produced well fluid into the vertical cyclonic separator tangent to the inner surface of the vertical cyclonic separator through at least two inlets.

13. The method of claim 8, comprising communicating the liquid separated from the gas into the three-phase separator at or below a level of the oil-water interface in the three-phase separator.

14. The method of claim 13, further comprising conditioning the flow of the liquid communicated into the three-phase separator to minimize the turbulence of the flow.

15. A separator system comprising for separating gas and liquid in a well fluid comprising:
a vertical cyclonic separator comprising:
an upper section with an upper outlet at an upper end thereof;
a lower section with a lower outlet at a lower end thereof; and
a nozzle section removably connected between the upper and lower sections, the nozzle section having at least one well fluid inlet;
a well fluid inlet conduit communicating well fluid from a well fluid delivery line to the at least one well fluid inlet;
a gas flow conduit connected to the upper outlet of the vertical cyclonic separator and to the three-phase separator for communicating gas to the three-phase separator; and
a liquid flow conduit connected to the lower outlet of the vertical cyclonic separator and to the three-phase separator for communicating liquid to the three-phase separator.

16. The separator system of claim 15, wherein the nozzle section has at least two well fluid inlets, further comprising a nozzle connected to each well fluid inlet through which well fluid flows into the vertical cyclonic separator.

17. The separator system of claim 16, wherein the nozzles inject the well fluid tangent to the inner surface of the vertical cyclonic separator.

18. The separator system of claim 15, which in the vertical cyclonic separator is a cylindrical separator.

19. The separator system of claim 15, wherein the liquid flow conduit directs liquid from the vertical cyclonic separator into the three-phase separator horizontally.

20. The separator system of claim 15, further comprising a bypass conduit connected directly to the well fluid source and the three-phase separator to communicated well fluid directly into the three-phase separator from the well fluid source.
